(19) United States
(12) Patent Application Publication
(10) Pub. No.: US 2016/0298265 A1
(43) Pub. Date: Oct. 13, 2016

(54) SPIDER SILK AND SYNTHETIC POLYMER FIBER BLENDS

(71) Applicants: Randolph V. Lewis, Nibley, UT (US); Justin A. Jones, Nibley, UT (US); Ibrahim Hassounah, Roanoke, VA (US); Ethan J. Abbott, North Logan, UT (US)

(72) Inventors: Randolph V. Lewis, Nibley, UT (US); Justin A. Jones, Nibley, UT (US); Ibrahim Hassounah, Roanoke, VA (US); Ethan J. Abbott, North Logan, UT (US)

(73) Assignee: Utah State University, North Logan, UT (US)

(21) Appl. No.: 15/096,084

(22) Filed: Apr. 11, 2016

Related U.S. Application Data
(60) Provisional application No. 62/145,674, filed on Apr. 10, 2015.

(51) Int. Cl. D01D 5/00; C08L 77/02; C08L 77/04; C08L 33/02; C08L 71/02; D02G 1/02; C08L 61/02; C08L 29/04; C08L 33/06; C08L 33/20; D01D 10/02; C08L 75/04; C08L 69/00

(52) U.S. Cl. CPC D01D 5/0038; C08L 75/04; C08L 77/02; C08L 77/04; C08L 33/02; C08L 71/02; C08L 69/00; C08L 61/02; C08L 29/04; C08L 33/06; C08L 33/20; D01D 10/02; D02G 1/0293; D10B 2331/02; D10B 2331/10; D10B 2401/061; D10B 2401/063; D10B 2211/04

(57) ABSTRACT

Synthetic fiber blends and methods for preparing such fibers with spider silk proteins and synthetic and polymers are disclosed.

### RELATED APPLICATIONS

This application claims priority to U.S. Provisional Patent Application No. 62/145,674, filed Apr. 10, 2015, the entirety of which is incorporated by reference.

### GOVERNMENT FUNDING

This invention was made with U.S. Government support under NSF Grant Nos. IIP-1318194 and DMR1310387 awarded by the National Science Foundation. The Government has certain rights in this invention.

### BACKGROUND OF THE INVENTION

1. Field of the Invention

The present disclosure relates to recombinant spider silk and synthetic polymer fibers and methods for preparing such materials.

2. Description of the Related Art

Spider silks and other natural silks are proteinaceous fibers composed largely of non-essential amino acids. Orb-web spinning spiders have as many as seven sets of highly specialized glands that produce up to seven different types of silk. Each silk protein has a different amino acid composition, mechanical property, and function. The physical properties of a silk fiber are influenced by the amino acid sequence, spinning mechanism, and environmental conditions in which they are produced.

Dragline spider silk is among the strongest known biomaterials. It is the silk used for the framework of a spider web and used to catch the spider if it falls. For example, the dragline silk of A. diadematus demonstrates high tensile strength (1.9 Gpa; ˜15 gpd) approximately equivalent to that of steel (1.3 Gpa) and synthetic fibers such as aramid fibers (e.g., Kevlar™). Dragline silk is made of two proteins, Major Ampullate Spider Proteins 1 and 2 (MaSp1 and MaSp2). MaSp1 is responsible for the strength of dragline silk, while the MaSp2 is responsible for the elastic characteristics.

The physical properties of dragline silk balance stiffness and strength, both in extension and compression, imparting the ability to dissipate kinetic energy without structural failure. Due to their desirable mechanical properties, proteinaceous fibers and silks may be desirable for new biomaterials, drug delivery, tendon and ligament repair, heart valves replacements, tissue engineering, nerve regrowth stands, as well as athletic gear, military applications, airbags, and tire cords among others.

Besides spider silks, a variety of synthetic fibers have also been produced in the art. For example, nylons are known as the first synthetic fibers commercialized in the market. Since their disclosure in 1935, nylons have generally found their way into many applications such as apparel, technical textiles, brush bristles or carpet, flexible electronics, automobiles, packaging, and electrical applications. They have desirable mechanical properties with high thermal and chemical stability.

In current research, there is great interest to manipulate nylon properties through the addition of nanofillers, nanotubes, etc. Due to the small size of nanofillers or molecules, the interactions between the nylon matrix and the surface of nanofillers and molecules will be numerous, causing an impact on the macroscopic properties. The macroscopic and mechanical properties of the electrospun nylon nanofibers vary significantly according to the composition, shape, type, and concentration of nanofillers. In spite of the progress made over the past century in polymeric fiber science and technologies, the search for a truly strong and tough fiber continues. It is of practical and scientific interest to explore the limit of strength and toughness of fibrous materials; and to examine the factors that contribute to the development of a combination of strength and toughness in materials. There is an ongoing need to develop alternate fibrous materials that have high level of combined strength and toughness as well as other physical characteristics.

### SUMMARY OF THE INVENTION

The present invention provides composition and methods for producing fibers comprising spider silk and synthetic polymers from electrospinning processes.

### BRIEF DESCRIPTION OF THE DRAWINGS

FIG. 1 is a schematic illustration showing a setup of production of electrospun yarns according to one embodiment of the invention.

FIG. 2 displays the western blot bands of synthesized MaSp1 spider silk proteins extracted and purified from the modified goat milk. The thick band at 60 kDa corresponds to MaSp1 protein.

FIG. 3 is SEM graphs showing the reduction of electrospun nanofibers diameters by addition of MaSp1: (A) Pure Nylon 66 electrospun nanofibers (144±23 nm); (B) Nylon 66+2.5 wt. % MaSp1 (165±22 nm); (C) Nylon 66+5 wt. % MaSp1 (189±32 nm); and (D) Nylon 66+10 wt. % MaSp1 (506±105 nm).

FIG. 4 is the FTIR spectra of nylon 66 and its blends with different concentrations of MaSp1 that show an increase the intensity of amide I, amide II (A) and amide III regions (B). The peaks in chart B characterize the a helix crystals (1238 cm⁻¹), beta sheets (1280 cm⁻¹) and the random coil (1262 cm⁻¹).

FIG. 5 displays the XRD 2-D pattern for electrospun nylon 66 mats of aligned nanofibers before and after the addition of MaSp1. A: Pure Nylon 66 mat, B: Nylon 66 blended with 5 wt. % MaSp1.

FIG. 6 is a schematic illustration demonstrating the existence and orientation of β-sheets in a nylon 66 matrix.

FIG. 7 displays DSC curves showing the shifting of the sharp peak to lower temperatures by addition of MaSp1.

FIG. 8 displays strain-stress curves show the mechanical properties of the electrospun Nylon 66 nanofibers containing different amounts of MaSp1.

FIG. 9 displays SEM graphs for electrospun Nylon 66 nanofibers containing 5 wt. % MaSp1 at different rotation speeds. A: 500 RPM (213±35 nm), B: 1000 RPM (153±38 nm), C: 1500 RPM (174±25 nm) and D: 2000 RPM (204±45 nm).

FIG. 10 is a schematic illustration showing the change of the electrospinning fiber diameter at different rotation speeds.

FIG. 11 displays the FTIR spectra of Nylon 66 containing 5 wt. % MaSp1 electrospun at different rotation speeds of the target. (A) displays wavelengths 1700-1500. (B) displays wavelengths 1310-1210.

FIG. 12 displays XRD 2-D diffraction patterns for Nylon 66 mats consisting of aligned nanofibers electrospun at different target's rotation speeds. A-D: Nylon 66 mats and E-F: Nylon 66/5 wt. % MaSp1 mats.

FIG. 13 displays DSC curves of electrospun nylon 66/5 wt. % MaSp1 at different rotation speeds.

FIG. 14 displays Stress strain curves of electrospun nylon 66/5 wt. % MaSp1 electrospun at different rotation speeds of the target.

FIGS. 15(A)-(D) display FTIR spectra showing that the peak intensity of amide I, amide II, and amide III regions are increased by annealing. 15(A): Amide I and II for nylon; 15(B) Amide III for nylon; 15(C) Amide I and II for nylon and MaSp1; 15(D) Amide III for nylon and MaSp1.

FIG. 16 displays XRD patterns for the Nylon 66 and Nylon 66/MaSp1 electrospun yarns before and after annealing at different rotation speeds. A and B: Electrospun Nylon 66 electrospun yarns before and after annealing, respectively. C and D: Electrospun Nylon 66/5 wt. % MaSp1 electrospun yarns before and after annealing, respectively.

FIG. 17 is a schematic illustration showing the formation of β-sheets before and after annealing.

FIG. 18 displays DSC curves of electrospun nylon 66 and nylon 66/5 wt. % MaSp1 before and after annealing.

FIG. 19 displays stress strain curve of nylon 66 electrospun yarns with MaSp1 before and after annealing. 19(A) nylon and MaSp1; 19(B) nylon.

FIG. 20 displays the mechanical properties of TPU yarns vs blended TPU yarns containing MaSp1 electrospun from HFIP.

FIG. 21 displays mechanical properties of TPU yarns vs blended TPU yarns containing MaSp1 electrospun from DMF.

### DETAILED DESCRIPTION

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional” or “optionally” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

As used herein, the phrases “dope solution” or “spin dope” means any liquid mixture that contains silk protein and is amenable to extrusion for the formation of a biofilament or film casting. Dope solutions may also contain, in addition to protein monomers, higher order aggregates including, for example, dimers, trimers, and tetramers. Normally, dope solutions are aqueous solutions of between pH 4.0 and 12.0 and having less than 40% organics or chaotropic agents (w/v). In some embodiments, the dope solutions do not contain any organic solvents or chaotropic agents, yet may include additives to enhance preservation, stability, or workability of the solution. Dope solutions may be made by purifying and concentrating a biological fluid from a transgenic organism that expresses a recombinant silk protein. Suitable biological fluids include, for example, cell culture media, milk, urine, or blood from a transgenic mammal, cultured bacteria, and exudates or extracts from transgenic plants.

As used herein, the term “filament” means a fiber of indefinite length, ranging from microscopic length to lengths of a mile or greater. Silk is a natural filament, while nylon and polyester are synthetic filaments. A “blended filament” or “blended fiber” means a fiber that includes a silk or natural component and a synthetic component such as nylon or polyurethane for example.

As used herein, the term “toughness”” refers to the energy needed to break the fiber or filament. This is the area under the force elongation curve, sometimes referred to as “energy to break” or work to rupture.

As used herein, the term “elasticity” refers to the property of a body which tends to recover its original size and shape after deformation. Plasticity, deformation without recovery, is the opposite of elasticity. On a molecular configuration of the textile fiber, recoverable or elastic deformation is possible by stretching (reorientation) of inter-atomic and inter-molecular structural bonds. Conversely, breaking and re-forming of intermolecular bonds into new stabilized positions causes non-recoverable or plastic deformations.

As used herein, the term “fineness” means the mean diameter of a fiber which is usually expressed in microns (micrometers).

As used herein, the term “micro fiber” means a filament having a fineness of less than 1 denier.

As used herein, the term “modulus” refers to the ratio of load to corresponding strain for a fiber, yarn, or fabric.

As used herein, the term “orientation” refers to the molecular structure of a filament or the arrangement of filaments within a thread or yarn, and describes the degree of parallelism of components relative to the main axis of the structure. A high degree of orientation in a thread or yarn is usually the result of a combing or attenuating action of the filament assemblies. Orientation in a fiber is the result of shear flow elongation of molecules.

As used herein, the term “spinning” refers to the process of making filament or fiber by extrusion of a fiber forming substance, drawing, twisting, or winding fibrous substances.

As used herein, the term “tenacity” or “tensile strength” refers to the amount of weight a filament can bear before breaking. The maximum specific stress that is developed is usually in the filament, yarn or fabric by a tensile test to break the materials.

As used herein, the term “substantially pure” is meant substantially free from other biological molecules such as other proteins, lipids, carbohydrates, and nucleic acids. Typically, a dope solution is substantially pure when at least 60%, more preferably at least 75%, even more preferably 85%, most preferably 95%, or even 99% of the protein in solution is silk protein, on a wet weight or a dry weight basis. Further, a dope solution is substantially pure when proteins account for at least 60%, more preferably at least 75%, even more preferably 85%, most preferably 95%, or even 99% by weight of the organic molecules in solution.

### Suitable Silk Proteins

A variety of silk proteins can be used in the processes described herein. They include proteins from plant and animal sources, as well as recombinant and other cell culture source such as bacterial cultures. Such proteins may include sequences conventionally known for silk proteins (see for example, U.S. Pat. No. 7,288,391, incorporated herein by reference in its entirety).

Suitable spider silk proteins may be derived from conditioned media recovered from eukaryotic cell cultures, such as mammalian cell cultures, which have been engineered to produce the desired proteins as secreted proteins. Cell lines capable of producing the subject proteins can be obtained by cDNA cloning, or by the cloning of genomic DNA, or a fragment thereof, from a desired cell. Examples of mammalian cell lines useful for the practice of the invention include, but are not limited to BHK (baby hamster kidney cells), CHO (Chinese hamster ovary cells) and MAC-T (mammary epithelial cells from cows).

The spider silk proteins may be from several recombinant sources. Examples of such proteins recombinantly expressed include those identified in U.S. patent application No. 61/707,571; Ser. No. 14/042,183; PCT/US2013/062722; 61/865,487; and 61/917,259 that are incorporated herein by reference in their entirety, including recombinantly produced major ampullate, minor ampullate, flagelliform, tubuliform, aggregate, aciniform and pyriform proteins. These proteins may be any type of biofilament proteins such as those produced by a variety of arachnids including, for example, Nephila clavipes, Araneus ssp. and A. diadematus. Also suitable for use in the invention are proteins produced by insects such as Bombyx mori. Dragline silk produced by the major ampullate gland of Nephila clavipes occurs naturally as a mixture of at least two proteins, designated as MaSpI and MaSpII. Similarly, dragline silk produced by A. diadematus is also composed of a mixture of two proteins, designated ADF-3 and ADF-4.

The spider silk proteins may be monomeric proteins, fragments thereof, or dimers, trimers, tetramers or other multimers of a monomeric protein. The proteins are encoded by nucleic acids, which can be joined to a variety of expression control elements, including tissue-specific animal or plant promotors, enhancers, secretory signal sequences and terminators. These expression control sequences, in addition to being adaptable to the expression of a variety of gene products, afford a level of control over the timing and extent of production.

Suitable spider silk proteins may be extracted from mixtures comprising biological fluids produced by transgenic animals, such as transgenic mammals, including goats. Such animals have been genetically modified to secrete a target biofilament in, for example, their milk or urine (see for example, U.S. Pat. No. 5,907,080; WO 99/47661 and U.S. patent publication Ser. No. 20010042255, all of which are incorporated herein by reference). The biological fluids produced by the transgenic animals may be purified, clarified, and concentrated, through such techniques as, for example, tangential flow filtration, salt-induced precipitation, acid precipitation, EDTA-induced precipitation, and chromatographic techniques, including expanded bed absorption chromatography (see for example U.S. patent application Ser. No. 10/341,097, entitled Recovery of Biofilament Proteins from Biological Fluids, filed Jan. 13, 2003, incorporated herein by reference in its entirety).

The suitable spider silk proteins may originate from plant sources. Several methods are known in the art by which to engineer plant cells to produce and secrete a variety of heterologous polypeptides (see for example, Esaka et al., Phytochem. 28:2655 2658, 1989; Esaka et al., Physiologia Plantarum 92:90 96, 1994; and Esaka et al, Plant Cell Physiol. 36:441 446, 1995, and Li et al., Plant Physiol. 114:1103 1111). Transgenic plants have also been generated to produce spider silk (see for example Scheller et al., Nature Biotech. 19:573, 2001; PCT publication WO 01/94393 A2).

Exudates produced by whole plants or plant parts may be used. The plant portions can be intact and living plant structures. These plants materials may be a distinct plant structure, such as shoots, roots or leaves. Alternatively, the plant portions may be part or all of a plant organ or tissue, provided the material contains or produces the biofilament protein to be recovered.

Having been externalized by the plant or the plant portion, exudates are readily obtained by any conventional method, including intermittent or continuous bathing of the plant or plant portion (whether isolated or part of an intact plant) with fluids. Exudates can be obtained by contacting the plant or portion with an aqueous solution such as a growth medium or water. The fluid-exudate admixture may then be subjected to the purification methods of the present invention to obtain the desired biofilament protein. The proteins may be recovered directly from a collected exudate, such as a guttation fluid, or a plant or a portion thereof.

Extracts may be derived from any transgenic plant capable of producing a recombinant biofilament protein. Plant species representing different plant families, including, but not limited to, monocots such as ryegrass, alfalfa, turfgrass, eelgrass, duckweed and wilgeon grass; dicots such as tobacco, tomato, rapeseed, azolla, floating rice, water hyacinth, and any of the flowering plants may be used. Other useful plant sources include aquatic plants capable of vegetative multiplication such as Lemna, and duckweeds that grow submerged in water, such as eelgrass and wilgeon grass. Water-based cultivation methods such as hydroponics or aeroponics are useful for growing the transgenic plants of interest, especially when the silk protein is secreted from the plant's roots into the hydroponic medium from which the protein is recovered.

Spider silk proteins are designated according to the gland or organ of the spider in which they are produced. Spider silks known to exist include major ampullate (MaSp), minor ampullate (MiSp), flagelliform (Flag), tubuliform, aggregate, aciniform, and pyriform spider silk proteins. Spider silk proteins derived from each organ are generally distinguishable from those derived from other synthetic organs by virtue of their physical and chemical properties. For example, major ampullate silk, or dragline silk, is extremely tough. Minor ampullate silk, used in web construction, has high tensile strength. An orb-web's capture spiral, in part composed of flagelliform silk, is elastic and can triple in length before breaking. Tubuliform silk is used in the outer layers of egg-sacs, whereas aciniform silk is involved in wrapping prey and pyriform silk is laid down as the attachment disk.

Sequencing of spider silk proteins has revealed that these proteins are dominated by iterations of four simple amino acid motifs: (1) polyalanine (Alaₙ); (2) alternating glycine and alanine (GlyAla)ₙ; (3) GlyGlyXaa; and (4) GlyProGly(Xaa)ₙ, where Xaa represents a small subset of amino acids, including Ala, Tyr, Leu and Gln (for example, in the case of the GlyProGlyXaaXaa motif, GlyProGlyGlnGln is the major form). Spider silk proteins may also contain spacers or linker regions comprising charged groups or other motifs, which separate the iterated peptide motifs into clusters or modules.

In some embodiments, suitable spider silk proteins that can be used include recombinantly produced MaSp1 (also known as MaSpI) and MaSp2 (also known as MaSpII) proteins; minor ampullate spider silk proteins; flagelliform silks; and spider silk proteins described in any of U.S. Pat. Nos. 5,989,894; 5,728,810; 5,756,677; 5,733,771; 5,994,099; 7,057,023; and U.S. provisional patent application No. 60/315,529 (all of which are incorporated herein by reference).

The sequences of the spider silk proteins may have amino acid inserts or terminal additions, so long as the protein retains the desired physical characteristics. Likewise, some of the amino acid sequences may be deleted from the protein so long as the protein retains the desired physical characteristics. Amino acid substitutions may also be made in the sequences, so long as the protein possesses or retains the desired physical characteristics.

Synthetic Fiber Materials

A variety of synthetic fiber materials may be used. These include, but are not limited to: nylons such as nylon 6, nylon 11, nylon 12, nylon 6/6, nylon 6/9, nylon 6/10, nylon 6/12, nylon 4/6, nylon 6(3)T; para-aramid synthetic fibers such as Kevlar®, Nomex®, Technora®, Twaron®; poly(acrylonitrile) (PAN); acrylate polymers such as poly(methyl methacrylate) (PMMA), poly(acrylic acid), poly(methyl acrylate) (PMA), poly(acrylamide), poly(methacrylamide); synthetic and natural cellulose, cellulose derivatives such as cellulose acetate (CA), cellulose acetate butyrate (CAB), cellulose butyrate (CB), carboxymethyl cellulose (CMC), cellulose propionate (CP), cellulose triacetate (CTA), Ethyl cellulose (EC), hydroxyl ethyl cellulose (HEC), hydroxyl propyl cellulose (HPC), hydroxyl propyl methyl cellulose (HPMC), methyl cellulose (MC), poly(L-lactic acid) (PLA); poly(caprolacton) (PCL); poly(difluoro vinyldine) (PVDF); poly(ethylene sulfone) (PES); poly(vinyl alcohol) (PVA); poly(ethylene oxide) (PEO); poly(vinyl pyrolidone) (PVP); polyesters such as poly(ethylene terephthalate) (PET), poly(propylene terephthalate) (PPT), poly(butylene terephthalate) (PBT); poly(aniline) (PAni); synthetic and chitosan; poly(ethyleneimine) (PEI), polyimide (PI), poly(isobutylene) (PIB), poly(3-hydroxy butyrate), poly(styrene) (PS) and its derivatives such as poly m-methyl styrene (PMMS) and poly p-methyl styrene (PPMS), poly(styrene sulfonate) (PSS), polysulfone (PSU), poly(vinyl chloride) (PVC), poly(vinyl acetate) (PVAc), poly(1,4 butadiene), poly(isoprene), poly(chloroprene), poly(styrene acrylonitrile) (SAN), poly(styrene ethylene butadiene) (SEB), poly(styrene butadiene) (SBR), poly(styrene isoprene) (SIS), poly carbonate (PC), thermoplastic polyurethane (TPU) and synthetic and natural collagen.

As mentioned above, the synthetic fiber material may also be from a natural source such as cellulose and collagen.

In one embodiment, the synthetic fiber is a nylon. In one embodiment, the synthetic fiber is para-aramid. In one embodiment, the synthetic fiber is poly(acrylonitrile). In one embodiment, the synthetic fiber is an acrylate polymers. In one embodiment, the synthetic fiber is synthetic cellulose. In one embodiment, the synthetic fiber is natural cellulose. In one embodiment, the synthetic fiber is poly(L-lactic acid). In one embodiment, the synthetic fiber is poly(caprolacton). In one embodiment, the synthetic fiber is poly(difluorovinyldine). In one embodiment, the synthetic fiber is poly(ethylene sulfone). In one embodiment, the synthetic fiber is poly(vinyl alcohol). In one embodiment, the synthetic fiber is poly(ethylene oxide). In one embodiment, the synthetic fiber is poly(vinyl pyrolidone). In one embodiment, the synthetic fiber is a polyester. In one embodiment, the synthetic fiber is poly(aniline). In one embodiment, the synthetic fiber is synthetic chitosan. In one embodiment, the synthetic fiber is natural chitosan. In one embodiment, the synthetic fiber is poly(ethyleneimine). In one embodiment, the synthetic fiber is polyimide. In one embodiment, the synthetic fiber is poly(3-hydroxy butyrate). In one embodiment, the synthetic fiber is poly(styrene). In one embodiment, the synthetic fiber is a poly(styrene) derivative. In one embodiment, the synthetic fiber is poly m-methyl styrene. In one embodiment, the synthetic fiber is poly p-methyl styrene. In one embodiment, the synthetic fiber is poly(vinyl chloride). In one embodiment, the synthetic fiber is poly(vinyl acetate). In one embodiment, the synthetic fiber is poly(1,4 butadiene). In one embodiment, the synthetic fiber is poly(isoprene). In one embodiment, the synthetic fiber is poly(chloroprene). In one embodiment, the synthetic fiber is polycarbonate. In one embodiment, the synthetic fiber is synthetic collagen. In one embodiment, the synthetic fiber is natural collagen.

The durable mechanical properties of nylons are attributed to the formation of strong hydrogen bonds between nylon chains through different forms of crystal structures. Nylons exhibit two different kinds of crystals, a thermodynamically favorable form (α-form) and a thermodynamically unfavorable form (γ-form). During melt spinning and electrospinning of nylon 6, the crystal structure is converted from α-form to γ-form. The reverse conversion from γ to α forms can be done by annealing. The formation of γ crystals during spinning is attributed to the high stress applied to the nylon chains followed by rapid crystallization. The application of stress does not allow the necessary time for the chains to relax and form α crystals. Annealing the γ crystals by gradual melt and recrystallization results in the thermodynamic stable α form. The heating rate during annealing has to be manipulated to allow a relatively smooth transition from γ-form to α-form. Heating too quickly of the spun fibers can result in the melting of γ-form without transition into α-form.

Spider silk protein, for example MaSp1, was be blended with a synthetic material, for example nylon 66, to study its influence on crystallization and the mechanical properties of the produced yarns. The prepared dopes were spun into nanofiber mats and twisted into yarns. The electrospinning method was chosen as a nanofiber production method due to its versatility and simplicity. The electrospun fibers were aligned on a metallic cylinder and then twisted manually into yarns. The mechanical, thermal, and optical characterizations were then investigated.

Spin Dope Preparation

Spin dopes may be created using 10-40% weight protein/volume solvent (w/v). Spin dopes may be created using a variety of solvents and mixtures. In some embodiments, the primary solvent is 1,1,1,3,3,3,-hexafluoro-2-proponal (HFIP) which may be augmented with additives such as formic acid, propionic acid, anhydrous toluene, acetic acid, and isopropanol. In some embodiments, HFIP is the predominant constituent making up between 70 and 100% of the total volume of a spin dope. In some embodiments, organic acids can also be included, using up to 15% of each, in order to make a spin dope. Examples of suitable organic acids include formic acid, acetic acid, and propionic acid. In some embodiments, water is included in HFIP dopes, up to 50% of the volume. Water alone can be used for creating the spin dope for some of the polymers and proteins.

For example, spider dragline silk is composed of two proteins major ampullate silk protein 1 (MaSp1) and major ampullate silk protein 2 (MaSp2). Naturally, Nephila clavipes uses a ratio of 80% MaSp1 and 20% MaSp2. Shortened versions of these proteins can be used, generated by genetically altered goats. For the creation of synthetic fibers, varying ratios of MaSP1-like and MaSP2-like protein can be used in spin dopes, from 0-100% of either can be used to make fibers with appreciable properties. Other components can be added to the spin dope for solvation, preservation, and to impart desirable physical characteristics.

To create the dopes, protein is placed in a glass vial. Solvents are then added, and the vials is placed on a motorized rotator and allowed to slowly mix. Formic acid dopes require approximately 12 hours to completely mix. Acetic acid dopes using 25-30% protein can take up to 3 days to completely dissolve. Once the protein is dissolved, impurities exist and can be removed by centrifugation. Microwave heating can be used to accelerate this process.

Fiber Spinning

Electrospinning for the formation of the fibers disclosed herein can be used. In this electrostatic technique, a strong electric field is generated between a polymer solution contained in a glass syringe with a capillary tip and a metallic collection screen. When the voltage reaches a critical value, the charge overcomes the surface tension of the deformed drop of suspended polymer solution formed on the tip of the syringe, and a jet is produced. The electrically charged jet undergoes a series of electrically induced bending instabilities during passage to the collection screen that results in stretching. This stretching process is accompanied by the rapid evaporation of the solvent and results in a reduction in the diameter of the jet. The dry fibers accumulated on the surface of the collection screen form a non-woven mesh of nanometer to micrometer diameter fibers even when operating with aqueous solutions at ambient temperature and pressure. The electrospinning process can be adjusted to control fiber diameter by varying the charge density and polymer solution concentration, while the duration of electrospinning controls the thickness of the deposited mesh.

Electrospinning offers an effective approach to protein and synthetic component fiber formation that can potentially generate very thin fibers. Electrospinning silk fibers for biomedical applications is a complicated process, especially due to problems encountered with conformational transitions of silkworm fibroin during solubilization and reprocessing from aqueous solution to generate new fibers and films.

### Examples

### Materials

The synthesized spider silk dragline protein (MaSp1) is extracted from the milk of genetically modified goats. Formic acid (88%) was purchased from Alfa Aesar (Ward Hill, Mass., U.S.A.). Nylon 66 monofilament fishing lines were purchased from Rio Products (Idaho Falls, Id., USA), and the surfactant hexadecyl trimethyl ammonium bromide (HDTMABr) was purchased from Sigma Aldrich (St. Louise, Mont., U.S.A). All materials were used without any further treatments.

Milk Purification and Protein Extraction

The goats were milked with conventional machines and their milk was then ran through a cream separator to separate the fat from the milk. The defatted milk was mixed overnight with 21.07 g of arginine per liter of milk in order to obtain a pH of 9 and to stabilize the protein. Once mixed, the milk was pumped continuously through a cycle of two ultrafiltration hollow fiber cartridges, using a Masterflex I/P (Model: 77601-10, Cole-Parmer, Vernon Hills, Ill. USA). The first filter cartridge (Model #: UFP-750-E-9A, GE Healthcare, Pittsburgh, Pa. USA) has 750 kDa pores that are responsible for further defatting of the milk. The second filter cartridge (Model #: UFP-50-E-9A, GE Healthcare) has 50 kDa pores that filtered out unwanted proteins, and concentrated the desired proteins. The concentrated solution was then mixed with 159 g of ammonium sulfate per liter of milk to precipitate the proteins. Next, the protein was concentrated using an Avanti J-20 XP (Beckman Coulter, Brea, Calif. USA) centrifuge at 8500 rpm for 60 minutes. After centrifugation, the supernatant liquid was poured out, and the remaining salty, protein pellets were diluted with distilled water. The cycle of centrifuging and washing was repeated until the supernatant had a conductivity lower than 20 μS/cm to ensure that enough of the salt had been rinsed off. When sufficiently rinsed, the pellet was then lyophilized by a Freezone 4.5 Plus (Labconco, Kansas City, Mo. USA). The end product was a purified protein powder which can be used in the synthesizing of fibers.

Protein Characterization

The purified protein was characterized by a western blot procedure. Milk samples were taken during the purification. 25 μl of each sample was combined with 25 μl of 2× SABU loading buffer (8M urea, 6 mM EDTA, 10% SDS, 10% glycerol, 0.4% bromephenol blue, and 5% β-mercaptoethanol with 125 mM Tris-HCl as the solvent). The mixture was mixed well and then placed in boiling water for 2 to 5 minutes. Following this heat treatment, the samples were removed and centrifuged at 18,000 rcf for 30 seconds. The gel electrophoresis apparatus was then assembled and loaded with a 4-20% Tris-Hepes-SDS Precise™ Protein Gel (Thermo Scientific) and 500 mL of 1×SDS-PAGE running buffer (50 mg SDS, 605 mg Tris, and 1.19 g HEPES) was then poured into the reservoir. The dual color Precision Plus Protein™ standard (Bio Rad) was then loaded, followed by the samples which were loaded in the desired order in volumes between 10 μl and 30 μl. The electrophoresis was then started with the voltage at 100 volts for 60 to 70 minutes. Once complete, the Tris-Hepes gel was removed from its cassette and transferred. A nitrocellulose transfer membrane was used within the transfer apparatus which is then filled with 800 mL of 1× Towbin (303 mg Tris, 1.44 g glycine, and 10 mg SDS) and the transfer was performed for 60 minutes with constant amperage of 100 mA for each gel. After completion of the transfer, the nitrocellulose membrane was removed, and the western blot procedures were then performed on a shaker platform with mild agitation. The first step was to apply a primary block of 5% (w/v) powdered milk in TBS-T20 (2.4 g/L Tris, 8 g/L NaCl, Tween 20 0.5 mL/L, and pH to 7.4 with HCl) for 30 minutes. The primary antibody αM5 or αM4 was then added to the blocking solution for another 30 minutes. A TBS-T20 rinse was then performed on the membrane for approximately 5 minutes and another blocking step was applied. The secondary antibody donkey-anti-rabbit was then added to the second block and allowed to mix for 30 minutes. Following the completion of the secondary block and antibody another rinse was performed for an additional 5 minutes. The rinse was then dumped, and the NBT/BCIP 1-step development buffer was added to the membrane and developed for 5 to 10 minutes before being neutralized with water. The membrane was then allowed to dry, and the images were analyzed.

Dope Preparations

Different amounts of the MaSp1 extracted protein (2.50, 5 and 10 wt. %) and 0.75 g of nylon 66 monofilament fishing line (ca. 0.75 g) were dissolved in 3.1 mL of formic acid (88%) and 50 mg of HDTMABr. The mixture was sonicated at a power level of 3 watts for 15 minutes using Misonix Sonicator 3000 (Qsonica, Newton, Conn. USA) to guarantee homogeneous mixing of the spin dope.

Electrospinning

Pure nylon 66 and blended nylon 66/MaSp1 nanofibers were electrospun using an electrospinning instrument purchased from IME Technologies (KW Geldrop, the Netherlands). The used electrospinning device consists of syringe pumps (Harvard apparatus, model number: Harvard, USA), one 1-mL plastic syringes with a metallic needle having a 27 G diameter, and a rotatory target.

For the electrospinning process, the dope was filled in the plastic syringe and, it was supplied to the needle tip with a flow rate of 0.5 mL/h. A high voltage of 28 kV (+24 kV at the needle and −4 kV at the target) was applied between electrodes. The electrospinning was then run for two hours, in a closed chamber, at room temperature, and at a relative humidity of about 20%. The electrospun fibers were collected on the rotatory target which was covered with aluminum foil and rotated at speeds between 500-2000 RPM.

After electrospinning, the produced electrospun mat was peeled off from the aluminum foil and cut into strips with a width of 1 cm. The orientation of the strip was parallel to the spinning direction. Each strip as twisted using a fringe twister (Lacis cord maker and fringe twister, Berkeley, Calif., U.S.A.) for 15 seconds.

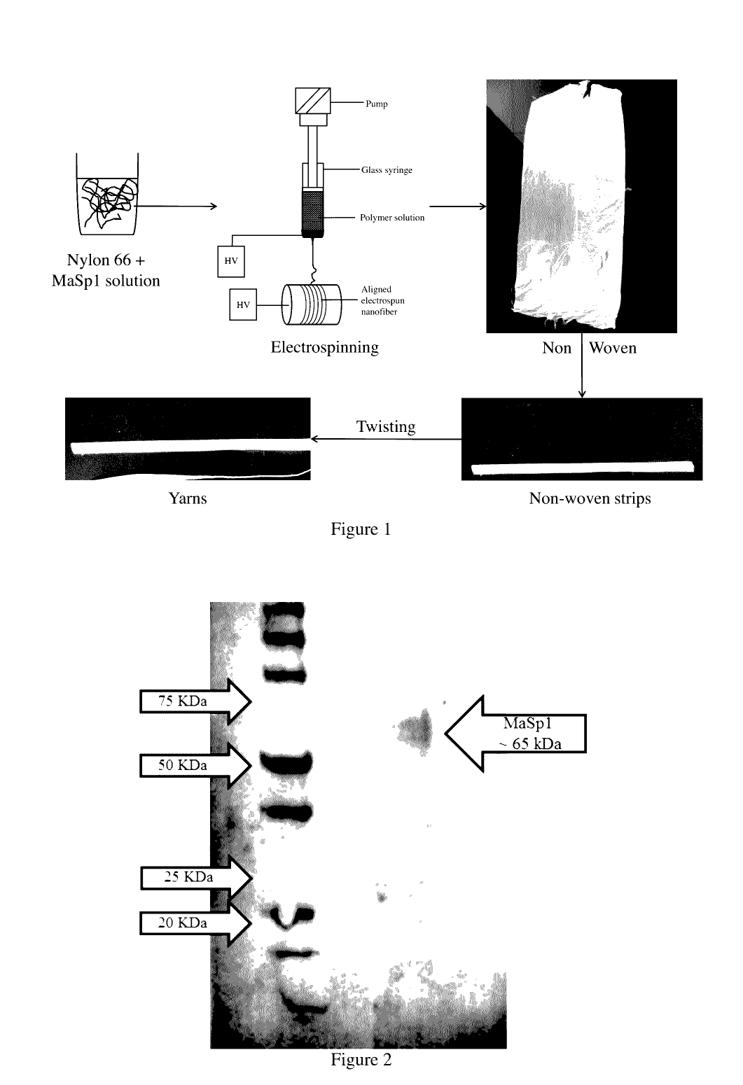

FIG. 1 illustrates the electrospinning and yarning processes.

Annealing

To study the influence of annealing on the crystal structure of nylon 66/MaSp1 electrospun yarns, the twisted yarns and mats were annealed inside a vacuum oven at 120° C. for one hour. After annealing, the twisted yarns and mats were allowed to cool to room temperature before further characterization.

Characterization

FE-SEM

The electrospun fibers were characterized by field emission scanning electron microscopy (FE-SEM Hitachi S-4000, Hitachi High-tech Corporation, Tokyo, Japan) to characterize their morphology and fiber diameter. The electrospun mats were mounted on an aluminum stub and coated with a gold layer of ca. 10 nm thick. An average fiber diameter was found by taking over 200 measurements using image J software.

FTIR

Fourier transform infrared (FTIR) spectroscopy was used to obtain spectra at ambient temperature, using a Shimadzu FTIR-8400 spectrometer (Shimadzu Corporation, Tokyo, Japan) to confirm the existence of MaSp1 and to observe any shift of peaks that characterize amide I, amide II, and amide III. Small, non-woven samples with a size of 3×3 mm were measured to collect specific spectra recognizing different functional organic groups of both the nylon 66 and the MaSp1 protein. The spectra collected was a result of running 32 scans at a resolution of 4 cm⁻¹.

X-Ray Diffraction

Electrospun mats were taken to the Advanced Photon Source located at Argonne National Laboratory, Argonne Ill., USA and X-ray fiber diffraction was performed on the BioCars 14bm-C beamline. The beam was set to a wavelength of 0.979 Å. Mats were stacked on top of each other to enhance the signal received from the synchotron beam. The mats were placed at a distance of 200 mm from the detector. The mats were placed so that the axis of rotation and, therefore, the alignment of nanofibers, was parallel to the beamstop. For a single image, data collection times were 30 seconds and five images were taken for each sample. The sample was then removed and background images were taken. Images were then processed using Fit2D software.

Dynamic Scanning Calorimeter (DSC)

The thermal properties of the electrospun nanofibers were measured by a DSC Q20 (TA instrument, New Castle, Del., U.S.A.). A 7-15 mg sample of the electrospun material was sealed in an aluminum pan and placed inside the DSC instrument. The samples were heated from room temperature up to 300° C., with a heating rate of 10° C./min. The data was exported and analyzed in MSExcel.

Mechanical Properties Test

The mechanical properties of the yarns were tested using an MTS tensile tester (Synergy 100, MTS, Eden Prairie, Minn. USA). The twisted yarns were fixed on a U-shaped plastic holder with a fixed length of 19.1 mm and secured in a tensile testing instrument. The tensile test ran at a strain rate of 5 mm/min. The recorded data was exported as an MSExcel file. The identified values are the average of at least 10 individual tests.

Protein Analysis

The purified MASpl protein extracted from goat's milk was analyzed by the western blot procedure. FIG. 2 shows the location of MaSp1 protein existing in the purified milk which appeared as a band in dried gel which is comparable to the standard protein. The massive bands of MaSp1 indicate that the molecular weight of the extracted protein is in the range of 65 kDa.

Influence of MaSp1 Concentration

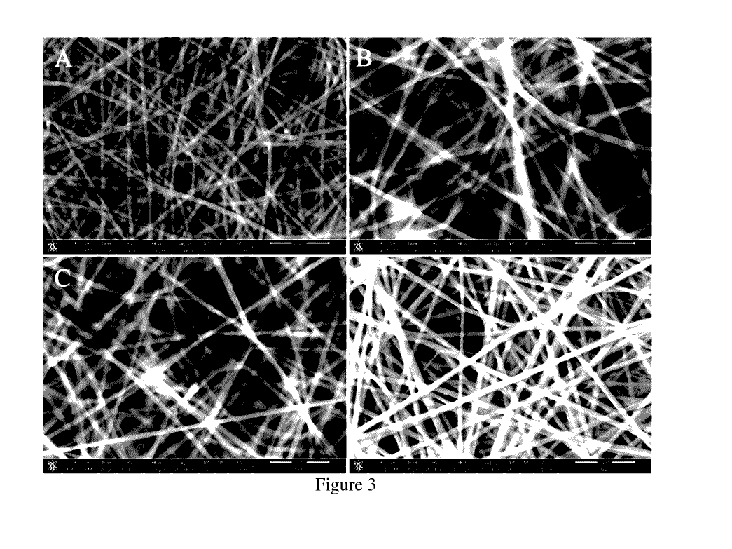

The electrospun nanofibers were characterized by FE-SEM. SEM graphs in FIG. 3 show that the fiber diameter increases with addition of the MaSp1 protein from 144±23 to 506±105 nm. While observing the mats on a macroscopic scale, the quality of the electrospun mesh improved with the addition of MaSp1, i.e. less macrodefects (droplets, fused areas, pinholes, etc.) were observed. This confirms that MaSp1 plays a major role in improving the ability to spin nylon 66. These tiny macrodefects on the electrospun mats influence the final mechanical properties significantly.

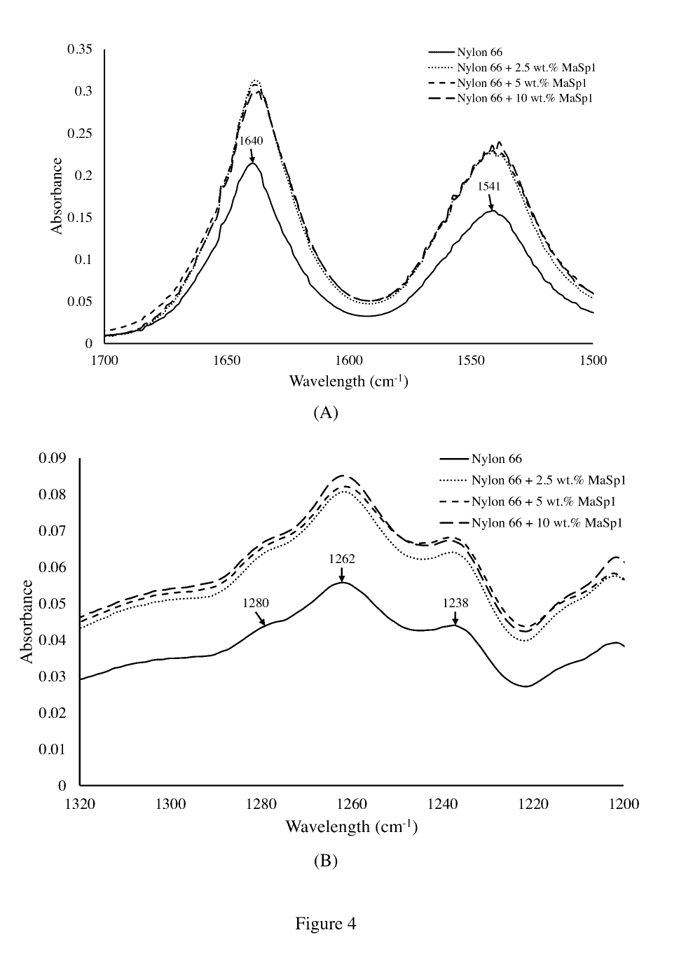

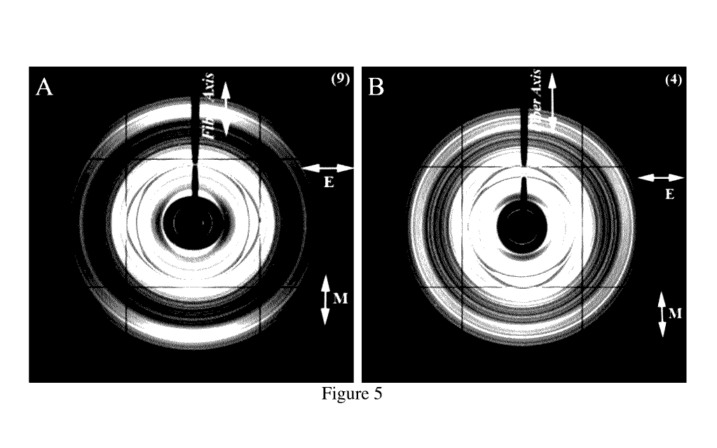

FTIR spectra was used to detect the specific spectra of amide I (1640 cm-1), amide II (1541 cm-1), and amide III (1220-1320 cm-1), the intensity of α helix (1238 cm-1), random coils (1262 cm-1), and β-sheets (1280 cm-1). It is hard to speculate from FTIR spectra if MaSp1 could influence crystallization within nylon 66 chains or not. The increase of the amide I, II, and III intensities indicate an increase of H-bonds between the protein (MaSp1) and the polymer matrix (nylon 66). The difference of the absorbance intensities at different concentrations of MaSp1 was minor. Yet, the presence of any MaSp1 in the absorbance intensity of the fibers was significant when compared to the pure, electrospun, nylon 66 fibers (FIG. 4).

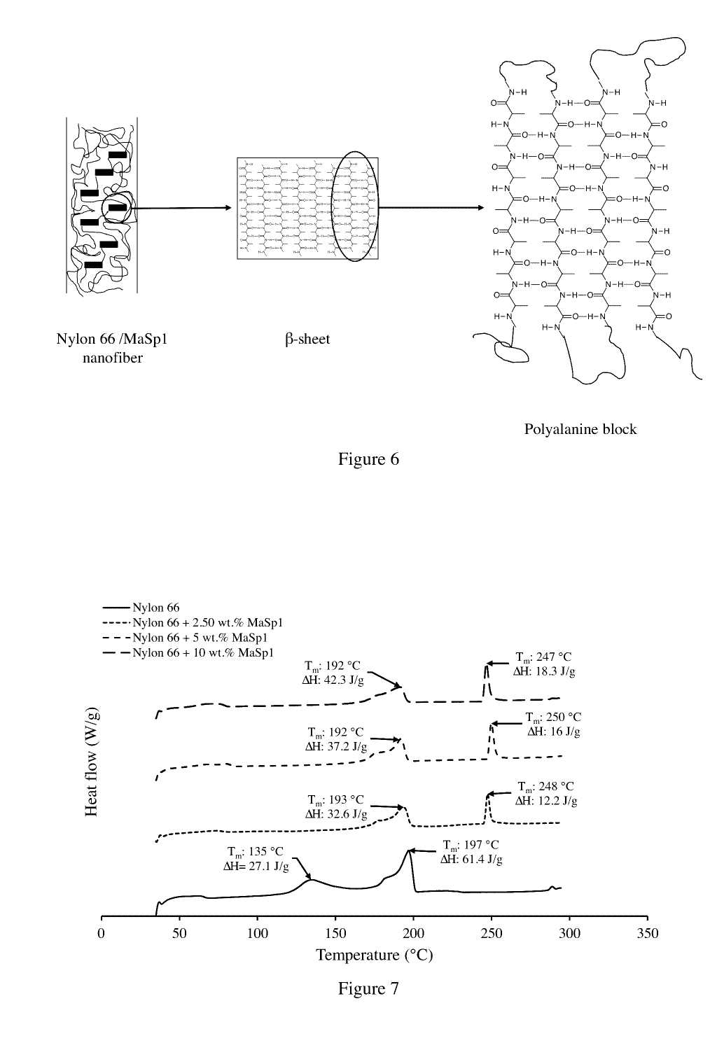

The X-ray 2-D diffraction pattern seen in FIG. 5 shows that the crystal orientation flipped 90° with the addition of MaSp1, from vertical to horizontal orientation. The flipping of the crystal orientation can be explained by destroying the crystal structure of nylon through the integration of the β-sheets of MaSp1 between nylon chains and separating the nylon chains far from each other. Polyalanine chains, which form β-sheets, are stretched and aligned parallel to the nanofiber's axis during electrospinning. The length of the polyalanine chains is limited to 10-12 monomeric units. In order to form β-sheets, the polyalanine chains gather together to crystalize and form β-sheets perpendicular to the nanofiber axis. Growth of β-sheets separates the nylon chains far from each other and reduces their chance to form crystals. FIG. 6 demonstrates the existence and orientation of β-sheets in the nylon 66 matrix.

DSC results in FIG. 7 confirm the existence of β-sheets with the sharp peak seen at 245-250° C. DSC results also show that the melt enthalpy and melting points of Nylon 66 were reduced (from 197° C. t 192° C. and from 61.4 J/g to 32 J/g, respectively. The reduction of melt enthalpies confirms that the crystal structure of nylon 66 was destroyed due to the separation of nylon 66 chains by MaSp1 β-sheets.

Addition of MaSp1 resulted in slight increases in the degree of crystallization resulting in an increase of the mechanical properties of the electrospun yarns.

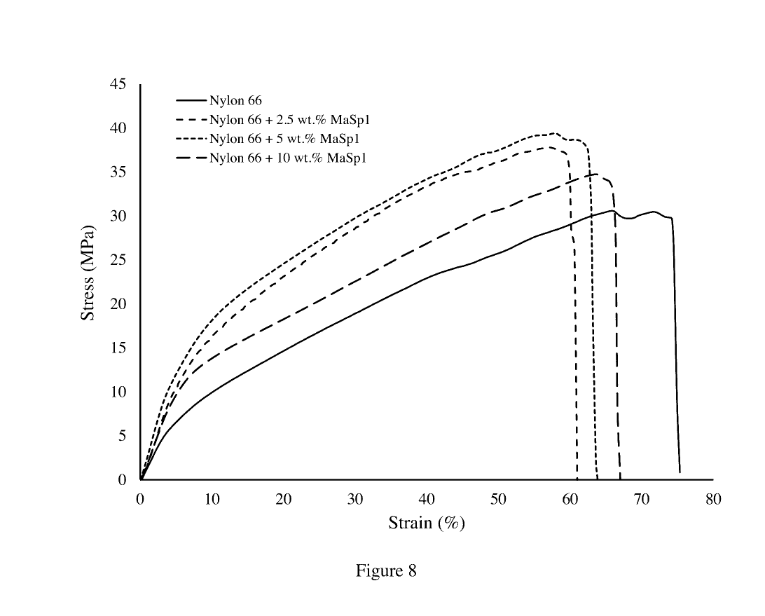

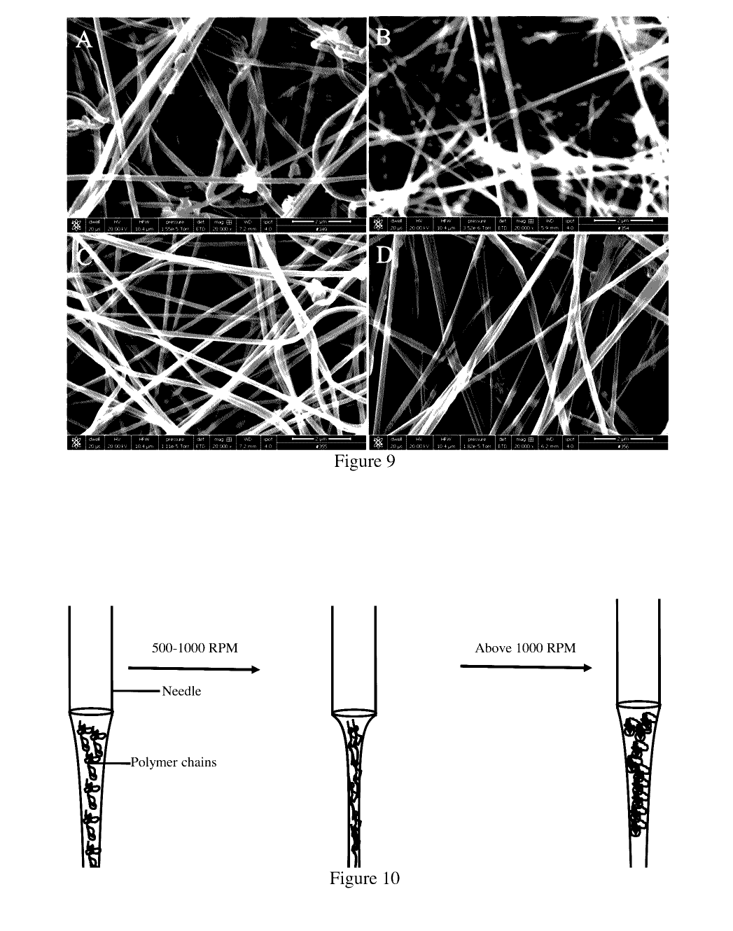

The stress-strain curves in FIG. 8 show that the elastic modulus, yield stress and ultimate stress increased with the addition of MaSp1 up to a concentration of 5 wt. %. Increasing the amount of the MaSp1 above 5 wt. % led to the reduction of mechanical properties. The addition of MaSp1 led to an increase of H-bonds between MaSp1 monomeric units and the nylon 66 chains. As MaSp1 causes destruction of the Nylon 66 crystal structure, the mechanical properties are reduced by further addition of MaSp1. β-sheets can act as bearings that lead the nylon chains to slide, therefore, the mechanical properties were reduced again.

Influence of Rotation Speed (Spinning Speed)

FIG. 9 shows that there is a certain degree of alignment of nylon 66 with MaSp1 when the rotation speed was increased from 500 to 2000 RPM. Alignment of nanofibers is important for the yarning process and is reflected in the final mechanical properties of the twisted yarns. The fiber diameters decreased by increasing the rotation speed up to 1000 RPM. When the rotation speed was increased above 1000 RPM, the fiber diameters increased. The fluctuation of fiber diameter can be explained by the existing balance between stretching forces and polymer relaxation time. As the drawing ratio increases, the polymer chains have enough time to relax before the polymer jet solidifies. At low rotation speeds (500 RPM) the spinning velocity is low and the relaxation time is high, resulting in the formation of large fibers. By increasing the rotation speed up to 1000 RPM, the stretching forces are higher, leading to the formation of thinner fibers. By further increasing the rotation speeds (above 1000 RPM), the polymer jet is greatly stretched and the polymer chains have enough time to relax, leading to the increase of the fiber diameter. FIG. 10 illustrates the reduction of the polymer jet diameter by first increasing the rotation speed, then increasing it again to faster rotations.

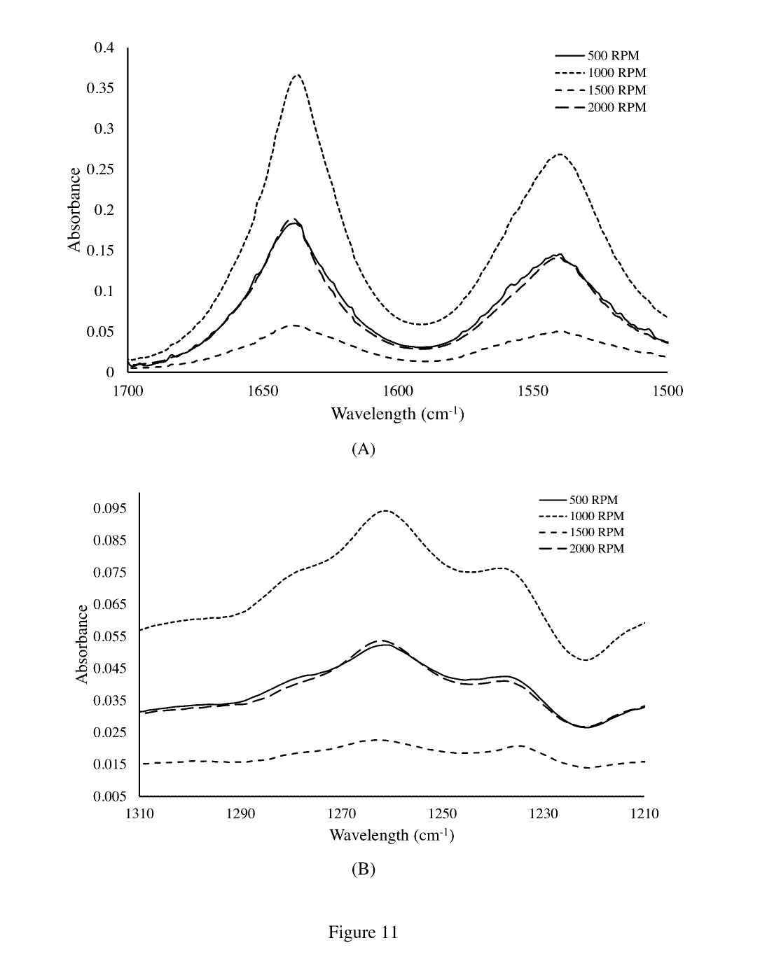

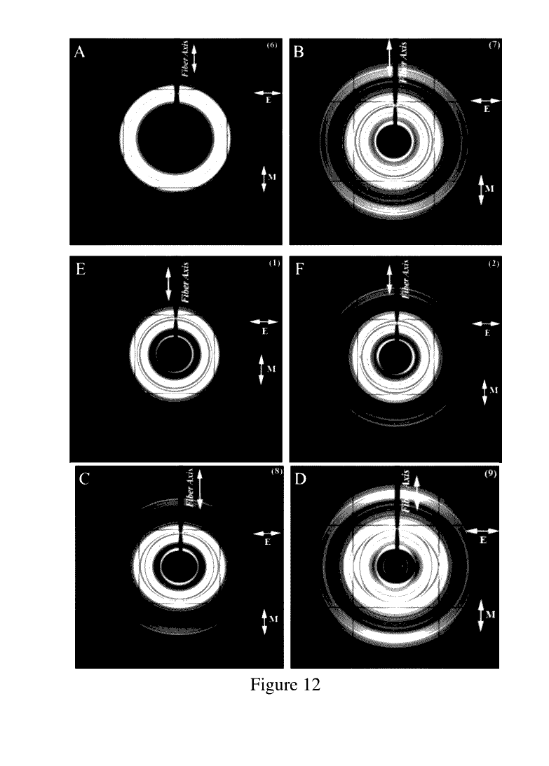

Surprisingly, the FTIR peak intensities characterizing amides I, II, and III increased up to rotation speeds of 1000 RPM and then decreased at speeds above 1000 RPM (see FIG. 11). This is due to the increase of crystallization intensities because of greater stretching forces.

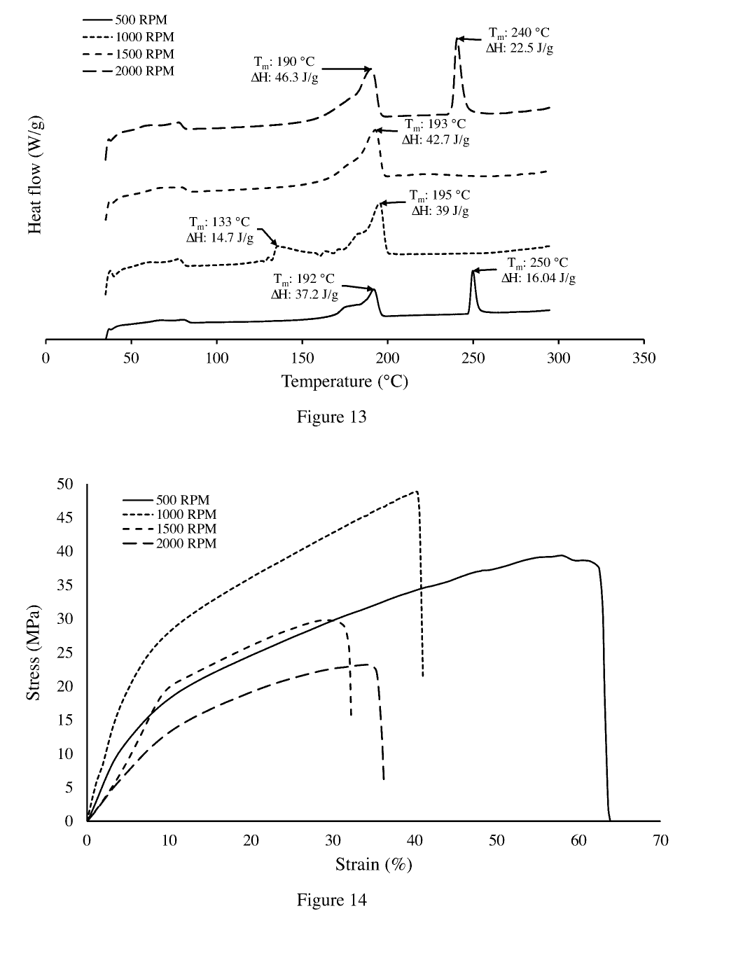

XRD 2-D patterns in FIG. 12 show that the intensity of crystallization increased with an increase of rotation speed of the target. Increasing the spinning rate led to stretching of the polymer chains along the nanofibers axis. The flipping of crystal orientation upon addition of MaSp1 is due to the integration of β-sheets within nylon 66 chains as explained previously. By comparing the XRD with DSC results in FIG. 13, it was observed that the sharp peak representing β-sheets at 245-250° C. ranges disappears at higher rotation speeds (1000-15000 RPM). The sharp peak appears again at 2000 RPM. This phenomenon can also be explained by the difference in the relaxation times between Nylon 66 and spider silk protein MaSp1. At low rotation speeds (500 RPM), the MaSp1 polyalanine blocks have enough time to form β-sheets. At higher target's rotation speeds (1000-1500 RPM), the β-sheets are destroyed and the MaSp1 chains integrate within Nylon 66 chains. There could be small β-sheets crystals formed of polyalanine blocks, which can be detected by XRD but not by DSC. At high rotation speeds (2000 RPM), the nylon 66 and MaSp1 chains do not have enough time to align along the axis of nanofibers. Due to high degree of mobility of MaSp1 comparable to Nylon 66 chains, MaSp1 can again form β-sheets at higher rotation speeds, which can be detected by both XRD and DSC. There is a possibility that a phase separation occurs between nylon 66 and MaSp1 at high rotation speed due to differences in the chains relaxation time.

The draw ratio also has an influence on the mechanical properties of the formed yarns. The stress-strain curves in FIG. 14 show that the strain of the yarn was by approximately 42% at higher rotation speeds. The higher strain at 500 RPM could be due to the random deposition of nanofibers on the target. During the tensile test, the deposited nanofibers are stretched and aligned, therefore, increasing the strain. At higher rotation speeds (1000 RPM), the electrospun nanofibers start to align on the target and the nylon chains also align along the nanofiber's axis, causing the elastic modulus, yield stress, and ultimate stress to increase significantly. The mechanical properties decrease at rotation speeds above 1000 RPM, despite having aligned fibers. This shows the importance of having a balance between the relaxation time of the polymer chains and the solidification of the polymer jet.

Influence of Annealing

Annealing should improve the thermal properties of the electrospun nanofiber. In order to increase the mechanical properties of the electrospun yarns, nylon 66 and nylon 66/MaSp1 were annealed at 120° C. for one hour. The fiber diameters were not altered significantly comparable to the non-annealed nanofibers.

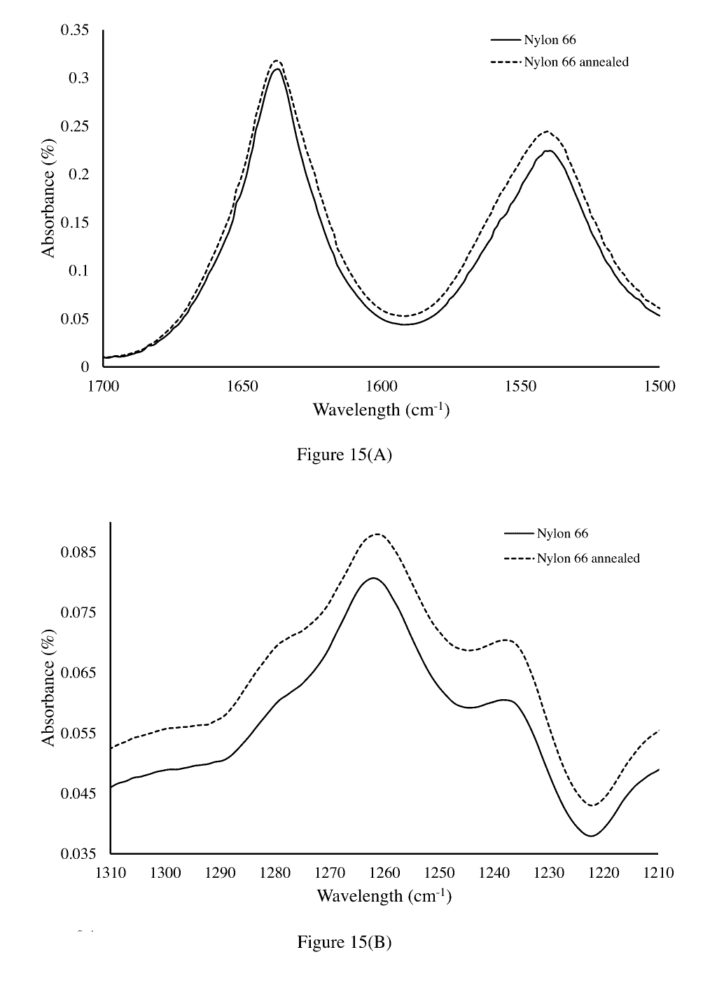

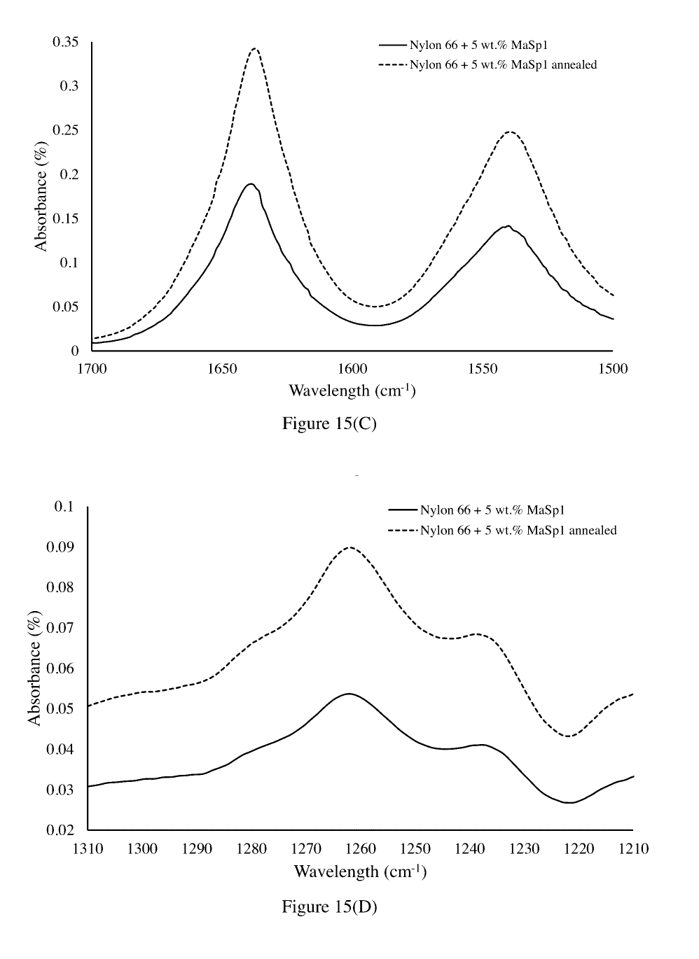

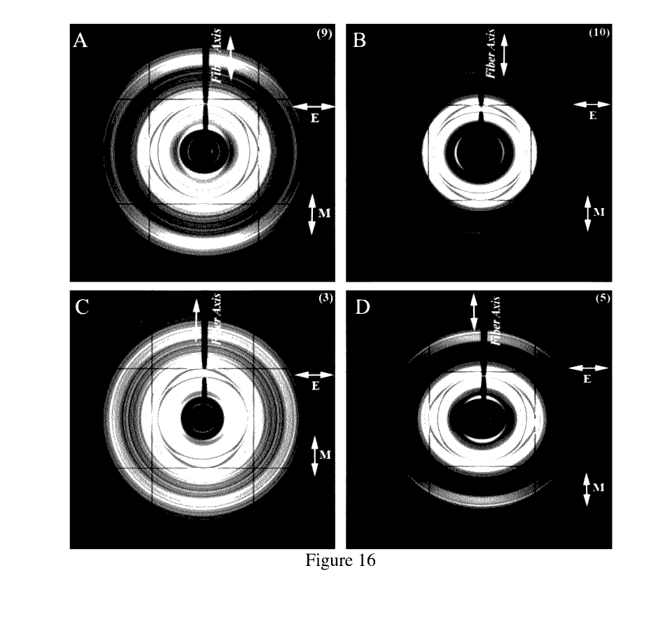

FTIR spectra, in FIG. 15, show the peak intensities of the annealed nylon 66 and nylon 66/MaSp1. The FTIR intensities of annealed yarns are higher than the annealed ones. This could be attributed to the relaxation and crystallization of the chains in the amorphous zones of the nanofibers.

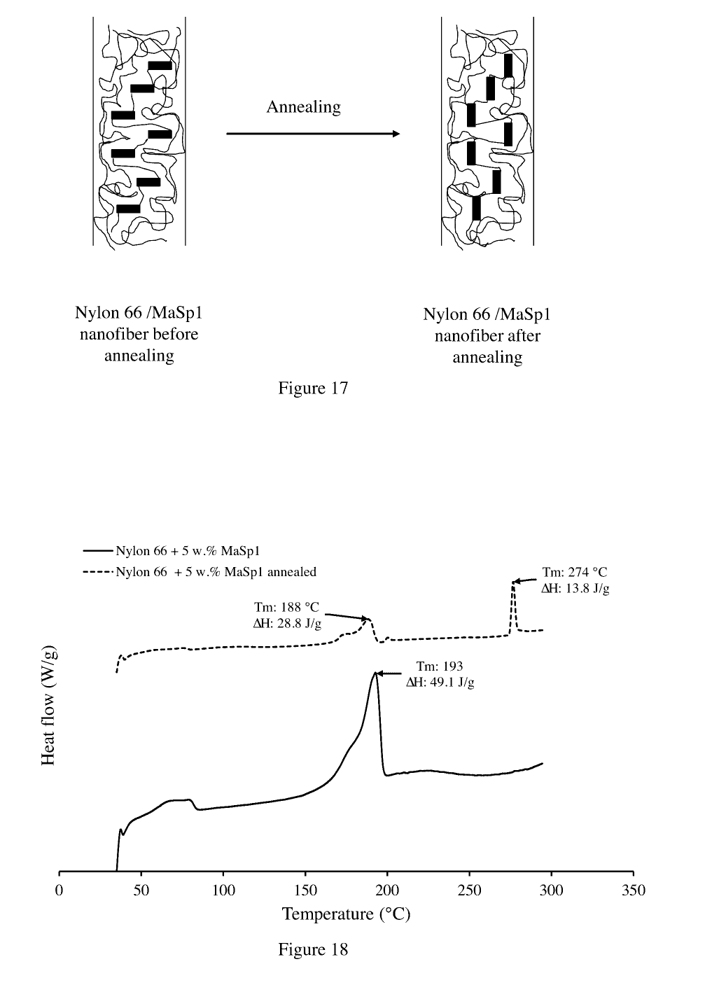

X-ray 2-D diffraction patterns demonstrated in FIG. 16 show that the orientation of crystals in the electrospun nanofibers was flipped 90° by annealing. The alteration of the crystal orientation could be attributed to the relaxation of the stretched nylon 66 and MaSp1 chains during annealing. The chain relaxation forces the crystals (β-sheets) to rotate as a result of chain contractions as shown in FIG. 17.

Upon annealing of the electrospun fibers, the melt enthalpy and degree of crystallization of nylon 66 and the blended nanofibers were reduced. DSC curves, in FIG. 18, also show the formation of sharp peaks at 243 and 274° C. after annealing. The mobility of MaSp1 chains in the nylon 66 matrix can result in the formation of β-sheets The DSC results match with results obtained by FTIR in FIG. 15.

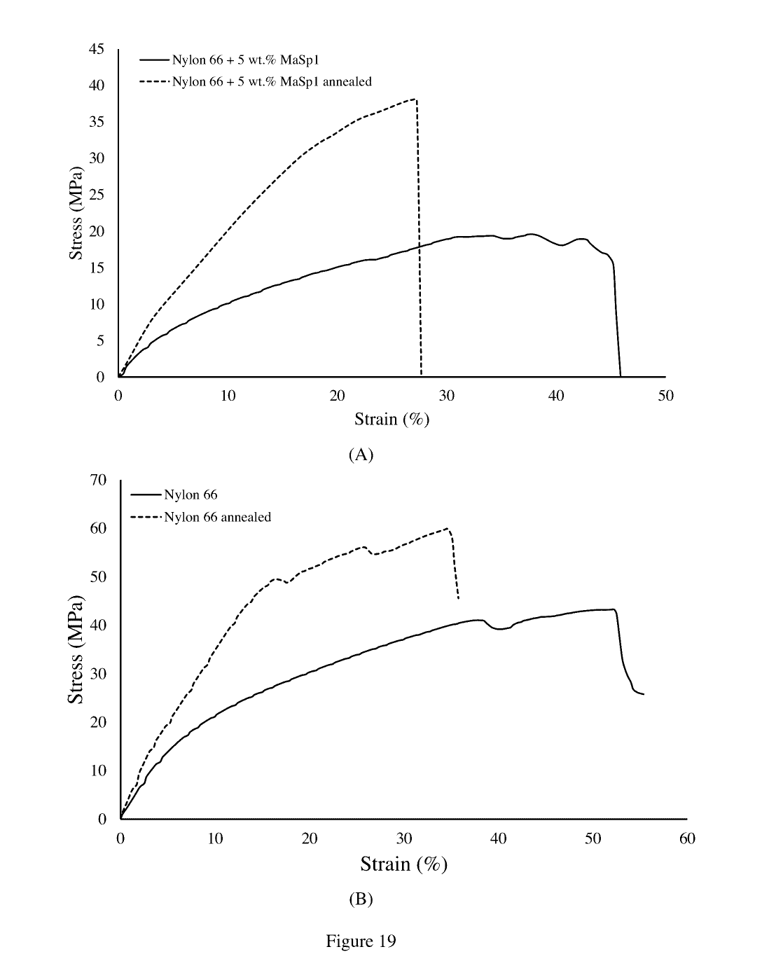

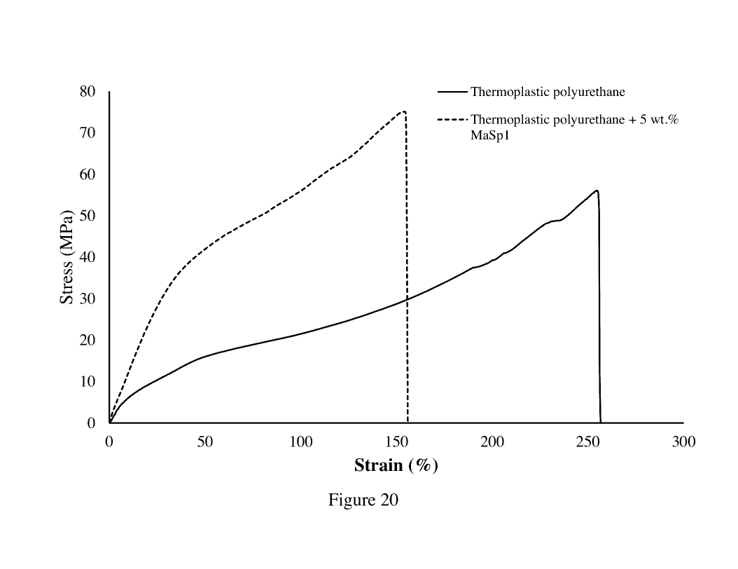

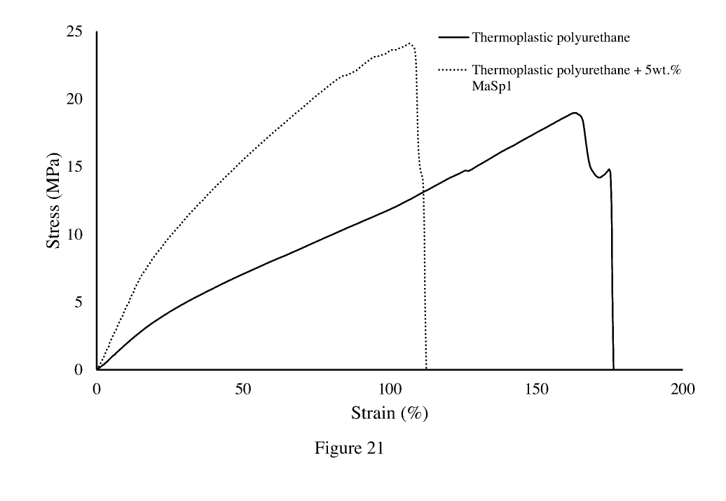

By annealing the electrospun nanofibers, the elastic modulus, yield stress, and ultimate stress increased, while the strain and energy-to-break were reduced significantly (see FIG. 19). The increase of the first three mechanical parameters could be due to the properties of MaSp1 since it is theorized to be the strengthening element in spider silk dragline. The reduction of the strain is also attributed due to the formation of the crystals in the nanofiber's matrix, which reduces the amount of amorphous zones. It is possible that the MaSp1 molecules assemble together and form tiny aggregates inside the nylon matrix. This conclusion is supported by the results obtained from XRD in FIG. 16 and DSC in FIG. 18.

The mechanical properties of nylon 66 electrospun yarns were enhanced by the addition of small amounts of spider silk protein. The spider silk protein is extracted from the milk of modified goats. First, different concentrations of MaSp1 were added to nylon 66 and electrospun into nanofibers using a rotatory drum as a target. A concentration of 5 wt. % MaSp1 is sufficient to enhance the mechanical properties by 75%. The addition of MaSp1 also causes alteration of the crystal orientation, resulting in an increase in the yarn's mechanical properties. Then the rotation speed of the target was altered. The mechanical properties of the electrospun yarns increase with rotation speed up to 1000 RPM and then it is begins to decrease. Annealing the electrospun yarns reduces the melt enthalpy, but enhances the formation of β-sheets. However, annealing increases the elastic modulus, yield stress, ultimate stress, but caused reduced strain. Also, annealing altered the orientation of β-sheets due to the relaxation of nylon 66 and MaSp1 chains.

### Polyurethane Examples

For electrospinning of thermoplastic polyurethane and its blends with spider silk proteins, the components are dissolved in (1, 2, 3, hexafluoro isopropanol, HFIP) or chloroform. The dope was electrospun at applied voltage 28 kV (+24 at the needle and −4 kV at the rotatory target). The sample was collected on the rotated cylinder rotated at 1000 RPM and covered with non-sticky aluminum foil. The produced electrospun mats (its size ca. 4″×10″, area 40 square inch) are peeled of the non-sticky foil, cut into thin strips of width 0.5″ and twisted into yarns of diameter 200-500 μm using cable twister. The twisted yarns have been fixed on C-shape plastic holders of width 19 mm and the tensile test was done at displacement speed 250 mm/min.

In the first dope, pure thermoplastic polyurethane (TPU) was dissolved in HFIP at concentration 8 wt. % (0.24 g thermoplastic polyurethane and 2.76 mL HFIP) and electrospun and twisted as explained above.

For the second dope, 5 wt. % of MaSp1 (relatively to TPU) was added to the TPU solution and electrospun under the same condition. The composition of the second dope was (0.24 g TPU, 12 mg MaSp1 and 2.76 mL HFIP).

For the third dope, Thermoplastic polyurethane was dissolved in dimethyl formamide (DMF) at concentration 15 wt. % and electrospun and characterized under the same condition. The composition of the third dope is: 0.45 g TPU and 2.55 mL DMF).

Fourth dope composed of TPU and 5 wt. % MaSp1 are dissolved in DMF. (0.45 g TPU, 100 μL of MaSp1 solution in HFIP (5 wt. %) and 2.55 mL DMF).

MaSp1 was precipitated in DMF, but it was dispersed vigorously using vortexing.

TABLE 1

| | | Thermoplastic | |
|---|---|---|---|
| | Thermoplastic | polyurethane and | Increase or |
| | polyurethane | MaSp1 | decrease (%) |
| Energy of break | 368.1 | 385.6 | ↑4.7 |
| Elastic modulus | 0.7 | 1.2 | ↑61.3 |
| Strain (%) | 257.2 | 156.2 | ↓−39.3 |
| Strength at break | 56.1 | 75.1 | ↑33.9 |
| Tensile strength | 4.1 | 25.2 | ↑512.5 |

TABLE 2

| | | Thermoplastic | |
|---|---|---|---|
| | Thermoplastic | polyurethane | Increase or decrease |
| | polyurethane | and MaSp1 | (%) |
| Energy of break | 96.7 | 89.8 | ↓−7.2 |
| Elastic modulus | 0.2 | 0.5 | ↑154.8 |
| Strain (%) | 176.4 | 112.5 | ↓−36.2 |
| Strength at break | 19.0 | 24.1 | ↑27.0 |
| Tensile strength | 1.1 | 7.0 | ↑535.5 |

Additional exemplary data is set forth below in the following table:

Mechanical properties of basic polymer electrospun nanofibers

| | | Elastic | Tensile | Strength | | Energy |
|---|---|---|---|---|---|---|
| Polymer | Solvent | modulus | strength | at break | Strain | to break |
| CAB | Acetic | 0.43 | 0.22 | 2.34 | 18.08 | 1.41 |
| | acid | | | | | |
| M4 | HFIP | 0.76 | 2.5 | 4.21 | 16.77 | 2.76 |
| M5 | HFIP | 0.91 | 3.29 | 5.4 | 24.2 | 5.57 |
| MaSp2 | HFIP | 5.89 | 4.7 | 7.09 | 15.58 | 4.15 |
| bacterial | | | | | | |
| derived | | | | | | |
| Nylon 6 | Formic | 0.82 | 13.31 | 3.96 | 69.49 | 33.29 |
| | acid | | | | | |
| Nylon 6/10 | Formic | 0.86 | 3.28 | 7.76 | 85.12 | 26.06 |
| | acid | | | | | |
| Nylon 6/9 | Formic | 1.9 | 8.41 | 20.13 | 119.78 | 103.24 |
| | acid | | | | | |
| Nylon 6/6 | Formic | 4.32 | 12.22 | 62.14 | 52.05 | 111.1 |
| Reo | acid | | | | | |
| PAA 25400 | Water | 0.79 | 1.43 | 2.15 | 3.67 | 0.21 |
| PAN 15000 | DMF | 1.15 | 3.95 | 6.09 | 6.87 | 1.25 |
| PC | HFIP | 1.67 | 6.38 | 10.49 | 49.31 | 17.63 |
| PEO 30000 | Water | 6.85 | 10.74 | 32.24 | 62.49 | 277.3 |
| PEO 30000 | Formic | 0.15 | 0.39 | 2.27 | 100.92 | 8.06 |
| | acid | | | | | |
| PEO 90000 | Water | 1.86 | 1.1 | 3.69 | 11.51 | 1.6 |
| PLA | Chloro- | 2.22 | 6.23 | 9.62 | 41.86 | 17.88 |
| | form | | | | | |
| PLA | HFIP | 1.26 | 5.42 | 7.88 | 55.71 | 20.37 |
| PLA | HFIP | 0.74 | 3.56 | 6.94 | 76.36 | 121.47 |
| PMMA | Formic | 0.44 | 0.76 | 0.87 | 3.32 | 0.08 |
| | acid | | | | | |
| Poly | Formic | 2.7 | 9.81 | 13.03 | 7.41 | 2.87 |
| acryloamide | acid | | | | | |
| PVA 20500 | Water | 4.75 | 15.89 | 45.81 | 76.24 | 132.61 |
| SAN | HFIP | 0.4 | 0.78 | 2.31 | 5.13 | 0.27 |
| TPU | DMF | 0.22 | 1.75 | 31.84 | 175.65 | 146.67 |
| TPU | DMSO | 0.66 | 3.63 | 52.65 | 260.44 | 341.62 |
| TPU | HFIP | 0.35 | 5.39 | 54.69 | 280.48 | 413.92 |
| WSPE | Formic | 2.94 | 8.4 | 9.57 | 29.03 | 10.85 |
| | acid | | | | | |
| M4 | HFIP + | 2.01 | 3.46 | 6.66 | 22.31 | 6.13 |
| | Formic | | | | | |
| | acid | | | | | |

Additional exemplary data is set forth below in the following table:

Mechanical properties of polymer/spider
silk electrospun nanofibers

| Polymer | | Elastic | Tensile | Strength | | Energy |
|---|---|---|---|---|---|---|
| blend | Solvent | modulus | strength | at break | Strain | to break |
| Nylon 6 + | Formic | 1.17 | 6.12 | 19.88 | 57.82 | 41.18 |
| M4 | acid | | | | | |
| Nylon 6 + | Formic | 0.76 | 3.32 | 12.42 | 57.78 | 26.22 |
| M4/M5 | acid | | | | | |
| Nylon 6 + | Formic | 0.93 | 3.95 | 9.19 | 36.04 | 12.89 |
| M5 | acid | | | | | |
| Nylon 6/9 + | Formic | 0.91 | 4.31 | 14.3 | 129.84 | 71.88 |
| M4/M5 | acid | | | | | |
| Nylon 6/9 + | Formic | 0.59 | 2.82 | 8.69 | 88.36 | 28.94 |
| M5 | acid | | | | | |
| Nylon 6/9 + | Formic | 0.72 | 3.63 | 12.7 | 122.03 | 59.69 |
| M4 | acid | | | | | |
| Nylon 66 | Formic | 1 | 5.51 | 21.5 | 50.2 | 34.76 |
| Reo + | acid | | | | | |
| FLAS 3 | | | | | | |
| Nylon 66 | Formic | 0.85 | 4.34 | 23.34 | 58.91 | 43.99 |
| Reo + | acid | | | | | |
| FLYS 4 | | | | | | |
| Nylon 66 | Formic | 1.93 | 7.45 | 40.18 | 69.17 | 92.17 |
| Reo + | acid | | | | | |
| FLYS 4-KT | | | | | | |
| Nylon 66 | Formic | 1.19 | 7.55 | 23.62 | 50.39 | 41.23 |
| Reo + | acid | | | | | |
| FLYS3 | | | | | | |
| Nylon 66 | Formic | 1.45 | 7.15 | 24.48 | 49.79 | 43.12 |
| Reo + M4 | acid | 2.5 | 8.78 | 33.2 | 80.45 | 103.96 |
| | | 3.36 | 11.36 | 41.31 | 49.41 | 79.41 |
| | | 2.81 | 8.35 | 30.03 | 37.35 | 40.12 |
| | | 4.74 | 15.74 | 37.73 | 33.87 | 48.42 |
| | | 1.73 | 5.93 | 20.04 | 47.24 | 35.39 |
| | | 4.4 | 16.51 | 48.75 | 40.99 | 72.97 |
| | | 1.59 | 5.03 | 19.59 | 45.88 | 33.9 |
| | | 1.71 | 13.69 | 28.92 | 40.6 | 42.61 |
| | | 2.61 | 11.82 | 28.24 | 26.86 | 28.21 |
| | | 2.5 | 9.97 | 38.02 | 27.67 | 34.37 |
| | | 1.6 | 6.18 | 35.09 | 85.33 | 107.35 |
| | | 2.2 | 8.94 | 37.72 | 67.32 | 88.05 |
| | | 2.36 | 7.84 | 37.24 | 57.48 | 76.27 |
| | | 2.95 | 12 | 54.02 | 56 | 102.64 |
| | | 3.07 | 11.01 | 52.21 | 68.04 | 126.01 |
| | | 2.08 | 11.94 | 37.78 | 61 | 83.77 |
| | | 1.49 | 7.38 | 30.58 | 72.51 | 78.39 |
| Nylon 66 | Formic | 1.28 | 5.4 | 33.09 | 79.63 | 88.13 |
| Reo + | acid | | | | | |
| M4/M5 | | | | | | |
| Nylon 66 | Formic | 1.15 | 6.11 | 19.94 | 62.5 | 44.64 |
| Reo + | acid | | | | | |
| MaSp1 LBT | | | | | | |
| Nylon 66 | Formic | 1.34 | 4.28 | 30.67 | 96.03 | 96.28 |
| Reo + | acid | | | | | |
| MaSp2 | | | | | | |
| Bacterial | | | | | | |
| derived | | | | | | |
| PAA + M4 | Water | 0.79 | 1.43 | 2.15 | 3.67 | 0.21 |
| PC + M4 | HFIP | 0.54 | 2.13 | 4.13 | 39.74 | 6.51 |
| PEO | Water | 0.4 | 0.48 | 1.5 | 10.81 | 0.6 |
| 300000 + | | 0.37 | 0.92 | 2.38 | 42.05 | 4.35 |
| M4/M5 | | 2.24 | 1.66 | 4.71 | 19.76 | 4.26 |
| PEO | water | 2.23 | 1.98 | 9.91 | 25.73 | 35.92 |
| 900000 + | | | | | | |
| M4 | | | | | | |
| PEO | Water | 2.05 | 10.27 | 3.53 | 28.15 | 45.39 |
| 900000 + | | 1.31 | 3.23 | 1.24 | 30.1 | 15.69 |
| M4/M5 | | 2.71 | 6.1 | 2.61 | 18.43 | 4.64 |
| | | 2.23 | 4.94 | 1.29 | 8.62 | 1.71 |
| PEO | Water | 6.97 | 6.39 | 16.87 | 15.05 | 38.8 |
| 900000 + | | | | | | |
| M5 | | | | | | |
| PLA + M4 | HFIP | 0.99 | 4 | 7.46 | 118.32 | 40.82 |
| PLA + M4 | HFIP | 0.74 | 3.56 | 4.62 | 48.82 | 9.64 |
| PVA + M4 | Water | 1.15 | 3.27 | 17.2 | 136.39 | 83.54 |
| | | 8.08 | 23.75 | 39.35 | 14.15 | 21.89 |
| | | 3.04 | 9.98 | 45.46 | 45.37 | 66.79 |
| | | 0.91 | 2.33 | 23.14 | 161.48 | 90.6 |
| | | 1.11 | 3.47 | 7.63 | 26.39 | 7.84 |
| PVA + | Water | 3.52 | 3.54 | 16.3 | 37.25 | 22.46 |
| M4/M5 | | 4.12 | 5.09 | 19.19 | 33.3 | 24.51 |
| | | 6.14 | 8.59 | 26.19 | 37.49 | 37.45 |
| PVA + PVP | Water | 2.42 | 8.29 | 23.41 | 74.42 | 67.08 |
| PVA | Water | 6.13 | 19.24 | 37.84 | 63.07 | 98.05 |
| 250000 + | | 8.35 | 22.56 | 53.43 | 45.51 | 101.88 |
| PEO | | | | | | |
| 300000 + | | | | | | |
| M4 | | | | | | |
| PVA | Formic | 0.92 | 2.22 | 22.8 | 62.26 | 42.43 |
| 250000 + | acid | 1.93 | 6.75 | 54.05 | 47.76 | 76.12 |
| PEO | | | | | | |
| 300000 + | | | | | | |
| M4 | | | | | | |
| PVA | Water | 7.55 | 19.35 | 61.59 | 64.23 | 156.61 |
| 250000 + | | 6.94 | 19.86 | 48.09 | 54.76 | 106.44 |
| PEO | | | | | | |
| 900000 + | | | | | | |
| M4 | | | | | | |
| PVA | Formic | 1.18 | 3.31 | 19.46 | 47.22 | 30.48 |
| 250000 + | acid | 2.28 | 6.27 | 22.56 | 53.3 | 45.29 |
| PEO | | | | | | |
| 900000 + | | | | | | |
| M4 | | | | | | |
| PVA | Water | 4.93 | 14.28 | 51.01 | 68.24 | 131.44 |
| 250000 + | | 6.18 | 15.35 | 47.22 | 58.79 | 103.14 |
| PVP | | | | | | |
| 1300000 + | | | | | | |
| M4 | | | | | | |
| PVA | Formic | 2.68 | 6.6 | 31.58 | 38.68 | 38.21 |
| 250000 + | acid | 2.81 | 8.2 | 11.49 | 122.84 | 54.05 |
| PVP | | | | | | |
| 1300000 + | | | | | | |
| M4 | | | | | | |
| PVAc + M4 | Water | 0.44 | 0.87 | 16.19 | 123.06 | 44.97 |
| | and | | | | | |
| | formic | | | | | |
| | acid | | | | | |
| | (25/75) | | | | | |
| PVP | Water | 1.1 | 1.61 | 4.71 | 8.59 | 1.4 |
| 1300000 + | | 1.47 | 2.72 | 6.67 | 8.83 | 2.07 |
| M4/M5 | | 1.47 | 2.97 | 4.54 | 4.62 | 0.7 |
| SAN + M4 | HFIP | 0.6 | 4.85 | 6.48 | 16.28 | 3.32 |
| TPU + M4 | DMF | 0.46 | 7.04 | 24.1 | 112.49 | 89.76 |
| | | 0.42 | 3.22 | 26.06 | 231.86 | 179.76 |
| | | 0.6 | 3.64 | 34.37 | 215.41 | 234.42 |
| | | 0.47 | 2.02 | 22.6 | 45.06 | 32.11 |
| TPU + M4 | DMSO | 1.19 | 25.19 | 75.08 | 156.16 | 385.6 |
| TPU + M4 | HFIP | 0.85 | 10.26 | 115.6 | 143.6 | 457.7 |
| | | 0.15 | 1.07 | 9.7 | 127.2 | 36.64 |
| | | 0.03 | 0.59 | 3.04 | 201.04 | 18.53 |
| | | 0.09 | 0.42 | 8.92 | 102.21 | 25.76 |
| | | 0.16 | 2.78 | 29.21 | 279.19 | 215.36 |
| | | 0.18 | 2.18 | 23.77 | 243.89 | 162.39 |
| | | 0.71 | 4.06 | 36.1 | 161.2 | 180.74 |
| | | 0.14 | 1.13 | 13.03 | 227.65 | 83.94 |
| TPU + | HFIP | 0.27 | 1.27 | 5.98 | 528.91 | 112.72 |
| PEO | | | | | | |
| 300000 | | | | | | |
| TPU + | HFIP | 0.73 | 3.22 | 13.63 | 167.26 | 89.05 |
| PEO | | | | | | |
| 300000 + | | | | | | |
| M4 | | | | | | |
| WSPE + M4 | Formic | 3.11 | 7.93 | 10.33 | 79.44 | 29.29 |
| | acid | | | | | |
| Nylon 6 + | Formic | 1.2 | 6.1 | 19.9 | 57.8 | 41.2 |
| 5 wt. % | acid | | | | | |
| MaSp1 | | | | | | |
| Nylon 6 + | Formic | 0.9 | 4 | 9.2 | 36 | 12.9 |
| 5 wt. % | acid | | | | | |
| MaSp2 | | | | | | |
| Nylon 6 + | Formic | 0.8 | 3.3 | 12.4 | 57.8 | 26.2 |
| 5 wt. % | acid | | | | | |
| MaSp1/ | | | | | | |
| MaSp2 | | | | | | |
| (ratio 8:2) | | | | | | |
| Nylon 6/9 + | Formic | 0.7 | 3.6 | 12.7 | 122 | 59.7 |
| 5 wt. % | acid | | | | | |
| MaSp1 | | | | | | |
| Nylon 6/9 + | Formic | 0.6 | 2.8 | 8.7 | 88.4 | 28.9 |
| 5 wt. % | acid | | | | | |
| MaSp2 | | | | | | |
| Nylon 6/9 + | Formic | 0.9 | 4.3 | 14.3 | 129.8 | 71.9 |
| 5 wt. % | acid | | | | | |
| MaSp1/ | | | | | | |
| MaSp2 | | | | | | |
| (ratio 8:2) | | | | | | |
| HPMC + 5 | HFIP | 4.3 | 3.9 | 13.4 | 9.7 | 4.7 |
| wt. % aSp1 | | | | | | |
| Thermo- | HFIP | 1.2 | 25.2 | 75.1 | 156.2 | 385.6 |
| plastic | | | | | | |
| polyure- | | | | | | |
| thane | | | | | | |
| and MaSp1 | | | | | | |
| Poly(L- | HFIP | 1 | 4 | 7.5 | 118.3 | 40.8 |
| lactic | | | | | | |
| acid) + | | | | | | |
| 5 wt. % | | | | | | |
| MaSp1 | | | | | | |
| Water | Formic | 3.11 | 7.93 | 10.33 | 79.44 | 29.29 |
| soluble | acid | | | | | |
| Polyester + | | | | | | |
| 5 wt. % | | | | | | |
| MaSp1 | | | | | | |
| Nylon 6 + | Formic | 0.8 | 3.3 | 12.4 | 57.8 | 26.2 |
| 5 wt. % | acid | | | | | |
| MaSp1/ | | | | | | |
| MaSp2 | | | | | | |
| (8:2) | | | | | | |
| Nylon 6 + | Formic | 1.1 | 5.2 | 13.2 | 32.6 | 15.8 |
| 5 wt. % | acid | | | | | |
| MaSp1/ | | | | | | |
| MaSp2 | | | | | | |
| (8:2) + | | | | | | |
| OH-CNTs | | | | | | |
| Nylon 6 + | Formic | 1.9 | 5.2 | 10.8 | 21.2 | 8.1 |
| 5 wt. % | acid | | | | | |
| MaSp1/ | | | | | | |
| MaSp2 | | | | | | |
| (8:2) + | | | | | | |
| COOH- | | | | | | |
| CNTs | | | | | | |
| Nylon 6 + | Formic | 1.2 | 5.4 | 16.2 | 41.8 | 25 |
| 5 wt. % | acid | | | | | |
| MaSp1/ | | | | | | |
| MaSp2 | | | | | | |
| (8:2) + | | | | | | |
| NH2-CNTs | | | | | | |
| Nylon 6/9 + | Formic | 0.9 | 4.3 | 14.3 | 129.8 | 71.9 |
| 5 wt. % | acid | | | | | |
| MaSp1/ | | | | | | |
| MaSp2 | | | | | | |
| (ratio 8:2) | | | | | | |
| Nylon 6/9 + | Formic | 0.8 | 3.5 | 7.7 | 56.4 | 17.5 |
| 5 wt. % | acid | | | | | |
| MaSp1/ | | | | | | |
| MaSp2 | | | | | | |
| (8:2) + | | | | | | |
| NH2-CNT | | | | | | |
| Nylon 6/9 + | Formic | 1.3 | 5.4 | 12.4 | 72.9 | 36.7 |
| 5 wt. % | acid | | | | | |
| MaSp1/ | | | | | | |
| MaSp2 | | | | | | |
| (8:2) + | | | | | | |
| COOH- | | | | | | |
| CNT | | | | | | |
| Nylon 6/9 + | Formic | 1.1 | 5.3 | 14.2 | 102.4 | 58 |
| 5 wt. % | acid | | | | | |
| MaSp1/ | | | | | | |
| MaSp2 | | | | | | |
| (8:2) + | | | | | | |
| OH-CNT | | | | | | |

It will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A synthetic fiber comprising a spider silk protein and a synthetic polymer.

2. The fiber of claim 1, wherein the synthetic polymer is selected from: nylons, para-aramid, poly(acrylonitrile), acrylate polymers, synthetic or natural cellulose, poly(L-lactic acid), poly(caprolacton), poly(difluorovinyldine), poly(ethylene sulfone), poly(vinyl alcohol), poly(ethylene oxide), poly(vinyl pyrolidone), polyesters, poly(aniline), synthetic or natural chitosan, poly(ethyleneimine), polyimide, poly(3-hydroxy butyrate), poly(styrene) and its derivatives such as poly m-methyl styrene and poly p-methyl styrene, poly(vinyl chloride), poly(vinyl acetate), poly(1,4 butadiene), poly(isoprene), poly(chloroprene), polycarbonate and synthetic or natural collagen.

3. The synthetic fiber of claim 2, wherein the synthetic polymer is selected from nylon 6, nylon 11, nylon 12, nylon 6/6, nylon 6/9, nylon 6/10, nylon 6/12, and nylon 4/6.

4. The synthetic fiber of claim 1, wherein the spider silk protein is selected from natural and synthetic spider silk protein.

5. The synthetic fiber of claim 1, wherein the spider silk protein is MaSp1.

6. The synthetic fiber of claim 1, wherein the spider silk protein is MaSp2.

7. The synthetic fiber of claim 1, wherein the spider silk protein is a mixture of MaSp1 and MaSp2.

8. A method of producing a blended fiber, comprising:
adding a synthetic polymer to a solution comprising a recombinant spider silk protein; and
electrospinning the solution thereby forming a blended fiber.

9. The method of claim 8, wherein the solution further comprises immersing the blended fiber in an alcohol solution.

10. The method of claim 8, further comprising washing the blended fiber in water.

11. The method of claim 8, further comprising annealing blended fiber.

12. The method of claim 8, further comprising twisting the blended fiber to form a yarn.
